(19) United States
(12) Patent Application Publication
(10) Pub. No.: US 2020/0196177 A1
(43) Pub. Date: Jun. 18, 2020

(54) METHOD AND APPARATUS FOR SELECTIVE RADIO FREQUENCY SIGNAL METRIC COLLECTION VIA LOCATION

(71) Applicant: MOTOROLA SOLUTIONS, INC, CHICAGO, IL (US)

(72) Inventors: BRIAN W. PRUSS, STREAMWOOD, IL (US); ERIC P. GREBNER, GENEVA, IL (US); FELIX H GARRIDO, SCHAUMBURG, IL (US)

(21) Appl. No.: 16/223,187

(22) Filed: Dec. 18, 2018

(51) Int. Cl. H04W 24/10; H04W 4/021; H04W 16/18; H04W 24/02

(52) U.S. Cl. CPC H04W 24/10; H04W 24/02; H04W 16/18; H04W 4/021

(57) ABSTRACT

A method and apparatus for selective frequency signal metric collection via location is provided. A radio frequency (RF) analysis system may periodically send to a mobile device an indication of at least one geographic area of interest, the at least one geographic area of interest is based on an RF coverage heatmap. RF signal measurement may be received form the mobile device, wherein the mobile device takes RF signal measurements at a first rate when outside the at least one geographic area of interest and at a second rate when within the at least one geographic area of interest. The RF coverage heatmap may be updated based on the received RF signal measurements. The at least one geographic area of interest may be updated based on the updated RF coverage heatmap.

### BACKGROUND

In the field of mobile radio communications one of the most important aspects is ensuring that the communications system provides adequate radio frequency (RF) coverage within the region that is being served. Sufficient RF coverage is necessary in order to allow a user to utilize the system. Without proper RF coverage, communications are not possible. In the case of cellular telephony, insufficient RF coverage may lead to user dissatisfaction, inconvenience, and complaints. In the case of Land Mobile Radio (LMR) which may be utilized by first responders (e.g. police, fire, medical services), lack of RF coverage can literally put first responder's lives at risk.

RF planning typically begins by utilizing sophisticated engineering tools, such as simulators, to determine the number, placement, and power of various pieces of RF communications equipment (e.g. base stations, repeaters, etc.). The tools may take into account the geographic topology of the region being covered, human obstructions (e.g. buildings), or any other factors that may affect the ability of RF waves to propagate through the covered region. The tools may allow the RF engineer to predict expected coverage throughout the region being covered by the communications system.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an example of a geographic map representing an area of RF coverage, with areas of interest noted.

FIG. 2 is another example, of a geographic map representing an area of RF coverage with different areas of interest noted.

FIG. 3 is an example flow diagram of operation of an analysis system in accordance with the RF signal metric collection system described herein.

FIG. 4 is an example flow diagram of a mobile device providing RF signal metric collection according to the techniques described herein.

FIG. 5 is an example of an RF analysis system that may implement the RF signal metric collection techniques described herein.

FIG. 6 is an example, of a mobile device that may implement the RF signal metric collection techniques described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Although RF planning tools are extremely sophisticated and do an excellent job in predicting RF coverage, the very nature of RF propagation characteristics makes it virtually impossible for planning tools to be completely accurate in their RF coverage predictions. RF coverage can be impacted by any number of factors (e.g. solar flares, weather, foliage, new building construction, etc). RF coverage can even be impacted by the time of day or year. Thus, even with advances in planning tools, one of the most utilized techniques when performing RF planning is to go into the geographic area of coverage and take actual measurements of RF signal strength.

As mentioned, RF coverage can change over time due to various environmental factors. As such, it may be necessary to continuously monitor the RF coverage of a region even after the system is planned and deployed, in order to ensure that RF coverage remains satisfactory. One technique that may be utilized is to allow the mobile devices that are in the field to collect RF measurements and transmit those measurements to an RF analysis system. For example, in the case of an LMR system utilized by the police officers, the officers may be continuously patrolling the region. The police officer's radio could be commanded to make periodic RF measurements and supply those measurements to an RF analysis system. A similar technique may be used in a cellular telephony system, with the consumer's smartphones being instructed to take measurements. For the remainder of this description, a mobile device will be considered a device with an RF transceiver that is capable of taking at least RF signal measurements and providing those measurements to an RF analysis system.

A problem arises in that too much analytic data may overwhelm the infrastructure. For example, if every mobile device is constantly taking RF measurements and transferring those measurements to the RF analysis system, the RF analysis system may become overwhelmed by the influx of measurements. Furthermore, it is quite likely that much of the RF signal data that is being provided is irrelevant, as it may simply be confirming that the actual measured RF signal strength matches that which is expected.

The techniques described herein overcome these and other problems. A heatmap of the geographic area of interest may be created. The heatmap may indicate the RF coverage expected within various regions of the map. Initially, the heatmap may be populated with the RF coverage that was computed through the use of RF planning tools (e.g. computed measurements, not actual measurements). The mobile device may be instructed to collect RF signal measurements at a random interval. The interval may be selected to be large enough such that the RF analysis system does not become overloaded with measurements.

The measurements can be fed back into the RF coverage heatmap. Regions in which the measurements vary significantly from what is expected may be flagged as geographic areas of interest. The RF analysis system may notify the mobile devices of any geographic areas of interest. For example, GPS coordinates of geographic areas of interest may be provided. When entering a geographic area of interest, the mobile device may increase the rate at which RF signal measurements are taken, thus providing additional information to the RF analysis system. When leaving a geographic are of interest, the mobile device may return to taking RF measurements at a random interval.

The RF signal measurements may be utilized to update the RF coverage heatmap and possibly generate new areas of interest as well as remove areas of interest. The updated areas of interest may again be sent to the mobile devices. This process may iteratively continue as long as the system remains in operation. In some cases, the system operator may make changes to system parameters (e.g. RF output power, modifications to cell sectors, changes to antennae height, adding additional base stations/repeaters, etc.) to improve coverage. The techniques described herein may be utilized to ensure that those changes have the desired effect.

In addition, in order to reduce the amount of data that is collected by the mobile device, the mobile device may be instructed to stop taking any measurements under certain circumstances. For example, if the mobile device is not currently moving, it is very likely there will be no changes in RF signal strength measurements. As such, the mobile device may be instructed to stop taking RF signal strength measurements when stationary. As yet another example, there may be regions that will never be areas of interest, which may be referred to as excluded geographic regions. For example, in the case of a police LMR system, it may not be necessary to take RF measurements within the immediate area of the police station, as it would be expected that there would be a large concentration of police officers within the immediate vicinity of the police station and thus having all officer's mobile devices take RF signal measurements would be highly duplicative. Furthermore, coverage problems in the immediate vicinity of the police station would become readily evident.

An example method is provided. A radio frequency (RF) analysis system may periodically send to a mobile device an indication of at least one geographic area of interest, wherein the at least one geographic area of interest is based on an RF coverage heatmap. RF signal measurements may be received form the mobile device, wherein the mobile device takes RF signal measurements at a first rate when outside the at least one geographic area of interest and at a second rate when within the at least one geographic area of interest. The RF coverage heatmap may be updated based on the received RF signal measurements. The at least one geographic area of interest may be updated based on the updated RF coverage heatmap. In one aspect, the previous steps may be repeated.

In one aspect, the RF coverage heatmap includes expected RF signal measurements based on RF coverage calculations. In one aspect the method further comprises determining RF signal measurements are lower than expected in a geographic area and including the geographic area in the at least one geographic area of interest. In one aspect, the method further comprises detecting a suspected RF dead spot on the RF coverage heatmap and sending an alert to the mobile device indicating a location of the suspected RF dead spot, wherein the mobile device collects more detailed RF signal measurements when located within the suspected RF dead spot. In one aspect, the method further comprises correlating environmental conditions with the received RF signal measurements. In one aspect, the method further comprises receiving antenna orientation information from the mobile device and correlating the antenna orientation information with the RF signal measurements.

An example non-transitory processor readable medium containing a set of instructions thereon is provided. The non-transitory processor readable medium may contain a set of instructions thereon, that when executed by the processor cause the processor to send, periodically, from a radio frequency (RF) analysis system, to a mobile device, an indication of at least one geographic area of interest, wherein the at least one geographic area of interest is based on an RF coverage heatmap. The instructions further cause the processor to receive, from the mobile device, RF signal measurements, wherein the mobile device takes RF signal measurements at a first rate when outside the at least one geographic area of interest and at a second rate when within the at least one geographic area of interest.

An example method is provided. A mobile device including a radio frequency (RF) transceiver may periodically receive an indication of at least one geographic area of interest, the at least one geographic area of interest determined by a heatmap including RF signal measurements of a geographic area. The mobile device may take RF signal measurements at a first rate when the mobile device is outside the at least one geographic area of interest. The mobile device may take signal measurements at a second rate when the mobile device is inside the at least one geographic area of interest, wherein the second rate is higher than the first rate. The RF signal measurements taken at the first and second rates may be provided to an RF analysis system, wherein the RF signal measurements include geographic location information, wherein the RF analysis system updates the heatmap, periodically, by incorporating the RF signal measurements taken at the first and second rates into the heatmap and generates new geographic areas of interest based on the updated heatmap.

In one aspect, the method further comprises receiving, periodically, by the mobile device, the new geographic areas of interest. In one aspect, the method further comprises suspending RF signal measurements when the mobile device is in an excluded geographic region. In one aspect, the method further comprises suspending RF signal measurements when the mobile device is stationary.

In one aspect, the method further comprises storing the RF signal measurements taken at the first and second rates locally on the mobile device and providing the RF signal measurements to the RF analysis system when connected to the RF analysis system over a local connection. In one aspect, the method further comprises taking RF signal measurements at the second rate when the mobile device is outside the at least one geographic area of interest and the RF signal measurements have fallen below a threshold.

The instructions further cause the processor to update the RF coverage heatmap based on the received RF signal measurements. The instructions further cause the processor to update the at least one geographic area of interest based on the updated RF coverage map. In one aspect, the instructions further cause the processor to repeat the previous steps.

In one aspect, the RF coverage heatmap includes expected RF signal measurements based on RF coverage calculations. In one aspect, the instructions further cause the processor to determine RF signal measurements are lower than expected in a geographic area and include the geographic area in the at least one geographic area of interest. In one aspect, the instructions further cause the processor to detect a suspected RF dead spot on the RF coverage heatmap and send an alert to the mobile device indicating a location of the suspected RF dead spot, wherein the mobile device collects more detailed RF signal measurements when located within the suspected RF dead spot.

In one aspect, the instructions further cause the processor to correlate environmental conditions with the received RF signal measurements. In one aspect, the instructions further cause the processor to receive antenna orientation information from the mobile device and correlate the antenna orientation information with the RF signal measurements.

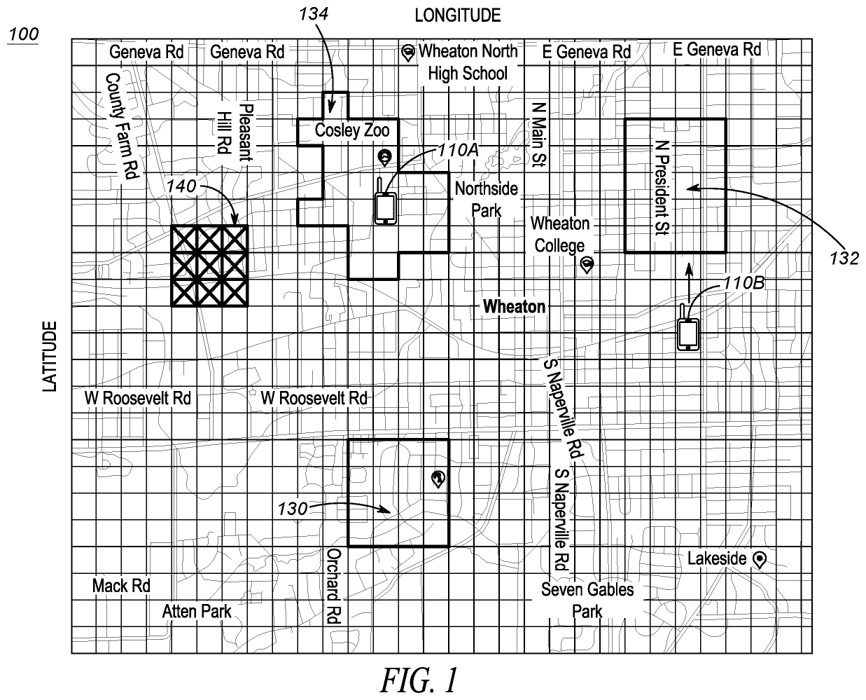

FIG. 1 is an example of a geographic heatmap representing an area of RF coverage, with areas of interest noted. FIG. 1 depicts a map 100 of a geographic area in which a wireless communications system may be provided. The map 100 may be maintained by an RF analysis system. The map may include coordinates that allow for various regions within the map to be identified. As shown, the example map 100 may use latitude and longitude coordinates (e.g. Global Positioning System (GPS) coordinates to identify various regions. For example, as shown, the map may be divided into a grid, with each block of the grid identified by a set of GPS coordinates.

In other implementations, the areas of interest may be identified using other types of coordinates. For example, a circle with a radius may be identified and the coordinates of that circle may be utilized. The areas of interest may be made larger or smaller based on the radius. In yet another implementation, geographic areas of interest may be identified by a free form set of coordinates that outline an irregular shape. The techniques described herein are not dependent on any particular form of defining an area. What should be understood is that there may be three types of geographic areas. First, there may be areas of interest. It is in these areas that mobile devices are to take RF signal measurements at a faster rate.

The second type of area may be excluded areas. Excluded areas are areas within the map 100 where mobile devices should not take any RF signal measurements. The third, and final type of area may be all areas that are neither in an area of interest nor an excluded area. This third type of area, may be referred to as a random interval area. When in a random interval area, the mobile device may periodically take RF signal measurements, but will do so at a rate slow enough that there is no need to worry that the data will cause an overload of the RF analysis system.

Initially, each are of the heatmap may be based on RF coverage calculation values that were calculated during the RF planning stages. For example, in an implementation that uses a grid, such as that depicted in FIG. 1, each box may be associated with an expected RF signal strength. Using a grid to define areas is simply for purposes of ease of description. It should be understood that the various areas may be defined using any type of geographical shape. As such, initially there may be no geographic areas of interest. It should be noted that throughout the disclosure, reference is made to RF signal measurements and RF signal strength, however this is for purposes of ease of description and is not intended to describe any specific metric. For example, RF signal measurements may include RF signal strength, bit error rates, frequency offsets, modulation deviation, or any other such parameters that may be used to characterize RF coverage.

Mobile devices 110(A,B) may be mobile devices that operate within geographic heatmap 100. These devices may be commanded to take RF signal measurements at a random rate. In some implementations, the rate may not be random, but may instead be at a slow enough rate that there is no need to worry about overwhelming the RF analysis system. The random or slower interval may also be referred to as the first rate. Mobile devices may travel throughout the geographic region periodically taking RF signal measurements at the first rate and reporting them the RF analysis system.

In some implementations, the mobile devices may report their RF signal measurements using the wireless communications system that is being measured. However, in other implementations, the mobile devices may provide the RF signal measurements in an offline manner. For example, when a user, such as a police officer, returns to the police station, he may directly connect his radio (via a wired connection or a high speed local wireless network such as Wi-Fi) to the RF analysis system. By doing so, there is no need to use RF bandwidth on the wireless communications system. In other cases, RF signal measurements may be sent by appending the measurements to communications that are already being performed by the mobile device. For example, if the mobile device is already periodically reporting location information, the RF signal measurements could be appended to the existing reporting messages. Regardless of how the RF signal measurements are provided, they will eventually be provided to the RF analysis system.

The RF analysis system may then update the heatmap with the actual measurements. From this update, the RF analysis system may be able to identify regions of interest. For example, as shown, regions 130, 132, and 134 may be regions of interest. A region may be of interest for different reasons. For example, a region may be of interest if RF signal measurements within that region are lower than what was calculated during the RF planning stages. Likewise, a region of interest may be created if RF signal measurements are higher than what was calculated. As will be explained in further detail below, speeding up the rate of data collection when in a region of interest may be desirable.

Heatmap 100 also may have excluded region 140. As mentioned above, there may be certain regions where taking RF signal measurements is not necessary. For example, in the area immediately surrounding the police station. In excluded regions, the mobile device may be instructed to discontinue taking any measurements when located in an excluded region.

It should be understood that geographic regions need not have any regular shapes. For example, although regions 130 and 132 are shown as square, region 134 is more irregularly shaped. It should be understood that there is no requirement that geographic areas of interest (or excluded areas) be of any particular shape. What should be understood is that any shape that can be identified and communicated to the mobile device may be utilized with the techniques described herein.

In operation, mobile devices 110(A,B) may receive an indication geographic areas of interest from an RF analysis system. For example, the geographic areas of interest may be identified by GPS coordinates. The Mobile devices may also receive an indication of excluded areas. Again, excluded areas may be identified using GPS coordinates. Finally, all areas that are not within areas of interest or excluded areas may be considered random interval, or first rate areas. The mobile device may take RF measurements at a first rate when in those areas.

For example, mobile device 110B is shown as outside any geographic area of interest or excluded area. As such, mobile device 110B may make RF signal measurements at a first rate. As explained, the first rate may be a rate that is defined to be slow enough that RF single measurements do not overwhelm the RF analysis system. As shown, mobile device 110B may be moving toward area of interest 132. Once mobile device 110B moves into area of interest 132, the mobile device may recognize that it has entered an area of interest. The mobile device may then begin taking RF signal measurements at a higher, second rate. This, the RF analysis system may have more data available for areas of interest vs excluded or other areas.

Mobile device 110A may be in area of interest 134 and as such may be taking RF signal measurements at the faster second rate. Mobile device 110A may be moving outside of the area of interest, as shown by the arrow. Once mobile device 110A leaves the area of interest, the mobile device may stop taking RF signal measurements at the faster second rate and revert to taking measurements at the slower first rate.

Although no mobile device is shown within excluded area 140, it should be understood that if a mobile device were to enter the excluded area, the mobile device would stop taking any RF signal measurements. In addition, in some implementations, the mobile device may be triggered to begin taking measurements at the faster, second rate, even when not in an area of interest. For example, a threshold may be provided and if RF signal measurements drop below that threshold, the mobile device may begin taking RF signal measurements at the faster, second rate, even if not located in an area of interest.

The mobile devices 110(A,B) may provide their RF signal measurements to an RF analysis system as will be described in further detail below.

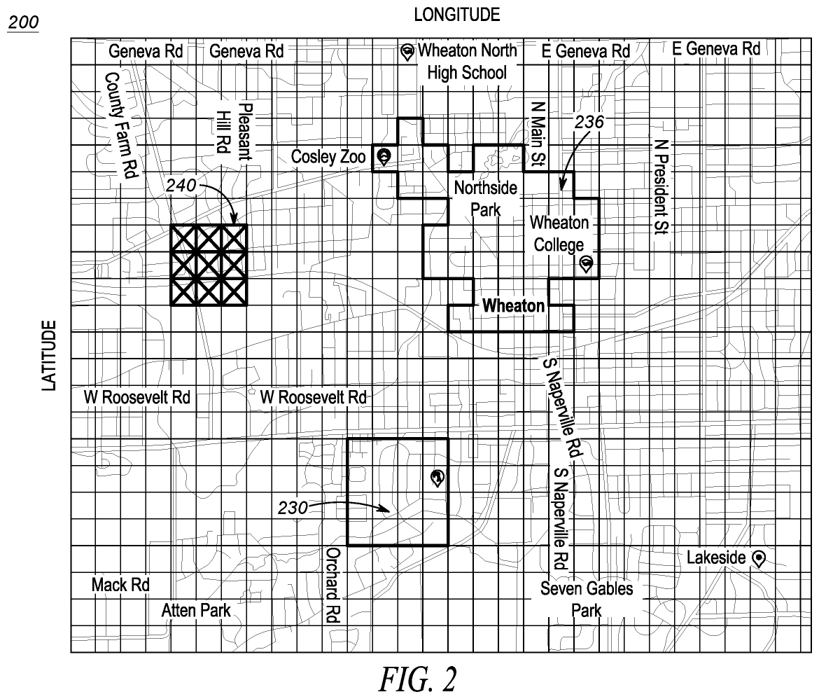

FIG. 2 is another example, of a geographic map representing an area of RF coverage with different areas of interest noted. As explained above, the mobile devices 110(A,B) may provide RF signal measurements to the RF analysis system. The RF analysis system may update the heatmap 200 by incorporating the RF signal measurements that were received. The RF analysis system may then generate new areas of interest based on the updated heatmap. For example, new areas of interest may be identified because the RF signal strength has fallen below what is expected in those areas. Previously identified areas of interest may no longer be areas of interest because the RF signal strength matches what is to be expected. What should be understood is that the heatmap is iteratively updated with data received from the mobile devices. Based on those updates, the areas of interest are updated.

It should be understood that areas of interest may be identified programmatically based on many different factors. As explained above, one factor could be that actual RF signal measurements are significantly different than expected RF signal measurements. Another possible criterion may include changes to RF signal measurements (e.g. an area that had acceptable coverage yesterday is now exhibiting unacceptable coverage). The areas of interest may also be determined manually. For example, a RF engineer may view the heatmap and identify areas that he would like to see additional data points. Those areas could be designated areas of interest in order to increase the rate of RF signal measurement that occurs in those areas. Regardless of how the new areas of interest are determined, those areas can be sent back out to the mobile devices.

As shown in map 200, certain areas may remain the same after the heatmap is updated. For example, excluded area 240 may be the same as excluded area 140, as would be expected since the excluded areas may be statically defined. Area of interest 230 may be similar to are of interest 130 because whatever the issue was that caused the area to be of interest in the first place may still exist. However, new areas of interest may also be created. For example, area of interest 236 does not have a corresponding region in heatmap 100. Likewise, previous areas of interest may be removed. For example, there is no equivalent of areas of interest 132,134 in heatmap 200. An area of interest may be removed if RF signal measurements in the area are expected values. For example, an area may be of interest because of low RF signal strength. An RF engineer may alter system parameters to correct the issue. Once corrected, the area may no longer be of interest, as it is operating as expected.

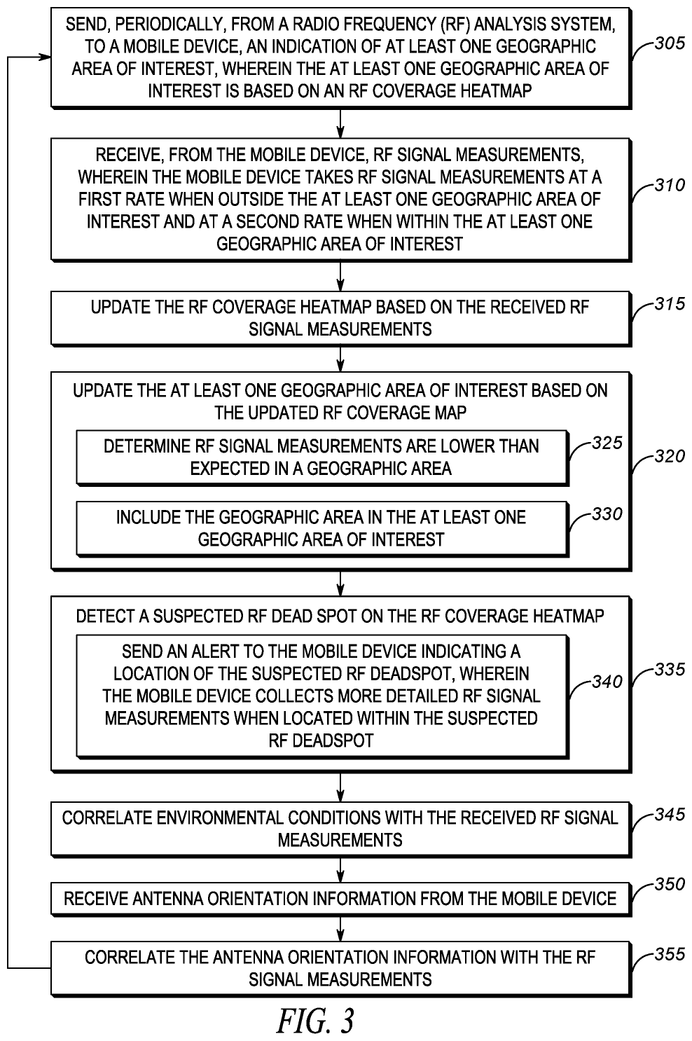

FIG. 3 is an example flow diagram of operation of an analysis system in accordance with the RF signal metric collection system described herein. In block 305, a RF analysis system may send, periodically, to a mobile device an indication of at least one geographic area of interest. The at least one geographic area of interest may be based on an RF coverage heatmap. As described above, the geographic coverage map of a wireless system may be viewed as a RF heatmap, wherein the RF coverage of the region is overlaid on the map. Certain areas, such as areas that are exhibiting RF coverage issues (e.g. signal strength less than expected, coverage drops, etc.) may be designated as areas of interest. Indications of those areas of interest may be sent to a mobile device. For example, the geographic areas of interest may be designated using GPS coordinates. Regardless of how determined, the mobile device may be made aware of geographic areas of interest of the RF coverage heatmap.

In block 310, RF signal measurements may be received from the mobile device. The mobile device may take RF signal measurements at a first rate when outside the at least one geographic area of interest. The mobile device may take RF signal measurements at a second rate when within the at least one geographic area of interest. The first rate is generally higher than the second rate meaning that more RF signal measurements are taken per unit time when taking measurements at the second rate. In other words, the RF analysis system informs the mobile device to take RF measurements at a quicker rate in portions of the heatmap that the RF analysis system is more interested in (e.g. because those areas are exhibiting abnormal/unsatisfactory coverage).

The mobile device may send the measurements to the RF analysis system. As explained above, in some cases, the mobile device may send those signal measurements using the wireless communications system itself. However, in order to reduce utilization of the wireless communications network, the mobile device may transmit RF signal information directly to the RF analysis system (e.g. via a wired connection or a high speed local wireless connection). Regardless of how transferred, the RF measurement data may be provided to the RF analysis system.

In block 315 the RF analysis system may update the RF coverage heatmap based on the received RF signal measurements. In other words, the RF analysis system updates the RF coverage heatmap to reflect the actual measured RF conditions vs a calculated (or previously measured) RF conditions. Thus, the RF coverage heatmap is updated with actual measured RF signal strength values that exist at that time (vs historical measurements).

In block 320, the at least on geographic area of interest may be updated based on the updated RF coverage heatmap. As described above, there may be different reasons why a geographic area may be of interest. For example, RF signal strength that is not what was expected based on RF planning, RF signal strength that has changed over time, RF signal strength that is greater than expected, or any other conditions which are not expected with respect to RF signal strength. These geographic areas of interest may change with time. For example, an RF engineer may change parameters of the system which may cause the RF coverage within a previous area of interest to become normal again. Likewise, RF parameter changes may cause an area that was not previously of interest to display anomalous behaviors, thus causing the are to become an area of interest.

What should be understood is that the RF coverage heatmap is changing based on RF measurements received from the mobile devices. The changes to the RF coverage heatmap may cause new geographic areas of interest to be created or may cause previous geographic areas of interest to no longer be areas of interest. As an example, in block 325 it may be determined that RF signal measurements are lower than expected in a geographic region. In block 330, the geographic region may be included in the at least one geographic area of interest. Thus, when the RF analysis system sends update geographic regions of interest to the mobile devices based on the updated heatmaps, the new geographic regions of interest will be pushed to the mobile devices. If a mobile device should find itself in an area of interest, it may begin taking RF measurements at the faster second rate.

In block 335, a suspected RF dead spot on the RF coverage heatmap may be detected. In some implementations, the suspected dead spot may become an area of interest to be periodically sent out to the mobile devices. However, in other implementations, a suspected RF dead spot may trigger a more immediate response. For example, in block 340, an alert may be sent to the mobile device indicating a location of the suspected RF dead spot. The mobile device may collect even more detailed RF signal measurements when located within the suspected RF dead spot. For example, the mobile device may begin collecting RF signal measurements at a rate even faster than the second rate.

In block 345, environmental conditions may be correlated with the RF signal measurements. As is known, weather events can impact RF propagation. For example, rain, snow, or lightning can have an impact on how RF propagates. Air temperature, and humidity may also impact RF propagation. Although wind itself does not affect RF propagation, it may cause movements of structures such as trees and buildings which may cause an impact. Thus, in block 345 environmental conditions may be collected and correlated with the RF signal measurements. This information may also be fed back into the RF coverage heatmap. The environmental information may potentially be used to determine if an area is truly of interest, or if it was experiencing temporary fluctuations due to weather conditions.

In block 350, antenna orientation information may be received form the mobile device. For example, the antenna orientation may be provided along with the RF signal measurements. As is known, antennas may be much more sensitive in certain orientations than in others. For example, some antennas may operate more efficiently when vertically oriented vs when horizontally oriented. Furthermore, antenna orientation may be useful to determine the position of the antenna relative to the source of the RF signal. For example, if the antenna is oriented such that the RF signal must pass through the user's body before being received, it will likely produce a lower signal strength than if the antenna was directly in the lie of sight of the RF source.

In block 355 the antenna orientation information may be correlated with the RF signal measurements. For example, lower than expected RF signal measurements when correlated with sub-optimal antenna orientation may not indicate there is an RF coverage issue, while low RF signal measurements that are correlated with optimal antenna orientation may indicate an issue. In the latter case, the geographic regions with the lower than expected RF signal measurements may be designated regions of interest.

As explained above, the process may be iterative. As such, the cycle from blocks 305-355 may continue to repeat. New regions of interest may be identified while previous regions of interest may be retired. Thus, the RF heatmap is continuously being updated with the current RF coverage conditions as they actually exist and are measured by the mobile devices.

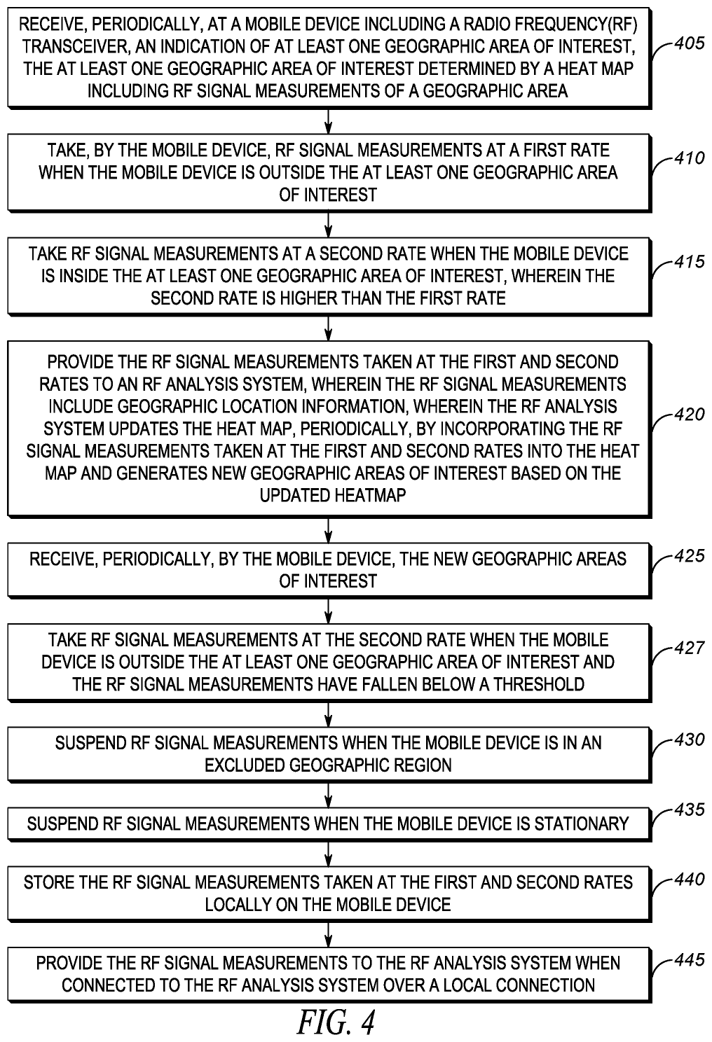

FIG. 4 is an example flow diagram of a mobile device providing RF signal metric collection according to the techniques described herein. In block 405, a mobile device that includes a radio frequency transceiver may periodically receive an indication of at least one geographic area of interest. The at least one geographic area of interest may be determined by a heatmap including RF signal measurements of a geographic area. As mentioned above, RF signal measurements is intended to describe a wide variety of RF coverage parameters, and is not limited to any specific type of RF coverage metric.

In block 410, the mobile device may take RF signal measurements at a first rate when the mobile device is outside the at least one geographic area of interest. For example, the first rate may be a random rate, with a range determined such that the number of RF measurements is not overwhelming to the RF analysis system. The first rate may be used in order to provide ongoing updates of RF signal measurements of areas of the geographic region that are not of particular interest at that time. In other words, measurements taken at the first rate may be utilized to ensure that the RF coverage heatmap is kept up to date, without requiring measurements at the faster rate be taken all the time.

In block 415, RF signal measurements may be taken at a second rate when the mobile device is inside the at least one geographic area of interest. The second rate may be higher than the first rate. As mentioned above, geographic areas of interest are those areas in which RF signal measurements are other than what is expected. By increasing the rate of measurement within those areas, a more detailed picture of the RF coverage situation within those geographic areas of interest may be obtained.

In block 420, the RF signal measurements taken at the first and second rates may be provided to an RF analysis system. The RF signal measurements may include geographic location information. The RF analysis system may update the heatmap, periodically, by incorporating the RF signal measurements taken at the first and second rates into the heatmap and generates new geographic areas of interest based on the updated heatmap. As described above, the RF coverage heatmap is continuously updated with RF signal measurements taken by the mobile device. Based on the current RF coverage, new areas of interest may be generated and previous areas of interest may be retired.

In block 425, the mobile device may periodically receive the new geographic areas of interest. Because the RF coverage heatmap is updated with current RF measurements, new areas of interest may be identified. These new areas of interest may periodically be sent to the mobile device. In some cases, the mobile device may increase the rate at which RF signal measurements are taken even when outside a geographic area of interest. For example, in block 427, RF signal measurements may be taken at the second rate when the mobile device is outside the at least one geographic area of interest and the RF signal measurements have fallen below a threshold. For example, the mobile device may be instructed that if RF signal measurements drop below a defined threshold, this indicates that a problem may exist (even if the mobile device is not currently in an area of interest). Thus, the mobile device may begin collecting RF signal measurements at the increased second rate until the measurements exceed the defined threshold.

In some cases, the mobile device may stop collecting RF signal measurements. For example, in block 430, RF signal measurements may be suspended when the mobile device is in an excluded geographic region. For example, there may be certain areas (e.g. in the parking lot immediately outside the police station) that the RF analysis system does not wish to receive RF signal measurements at all. For example, coverage in an excluded area may be deemed unimportant or the area is so well covered that there is no need to monitor the RF coverage of the area.

Similarly, in block 435, RF signal measurements may be suspended when the device is stationary. It should be understood that it is irrelevant if the mobile device is currently conducting RF signal measurements at the first or second rate. When the mobile device is not moving, it is expected that RF signal measurements will remain generally static. Thus taking repeated measurements that are likely to result in the same value is unnecessary. Thus, when the mobile device is stationary, the RF signal measurements may be suspended.

In block 440, the RF signal measurements taken at the first and second rates may be stored locally on the mobile device. In some cases, the mobile device may utilize the wireless communications system itself to send the RF signal measurements back to the RF analysis system. However, doing so may cause unnecessary strain on the wireless communications network. Instead, the mobile device may store the RF signal measurements local on the device itself, thus conserving wireless network bandwidth.

In block 445, the RF signal measurements may be provided to the RF analysis system when connected to the RF analysis system over a local connection. For example, the local connection may be a wired connection. For example, when an officer returns from patrol, he may connect his LMR radio via a wire to the RF analysis system in order to send the locally stored RF signal measurements. In other cases, the local connection may be a wireless connection, such as a high speed, short range WiFi or Bluetooth connection.

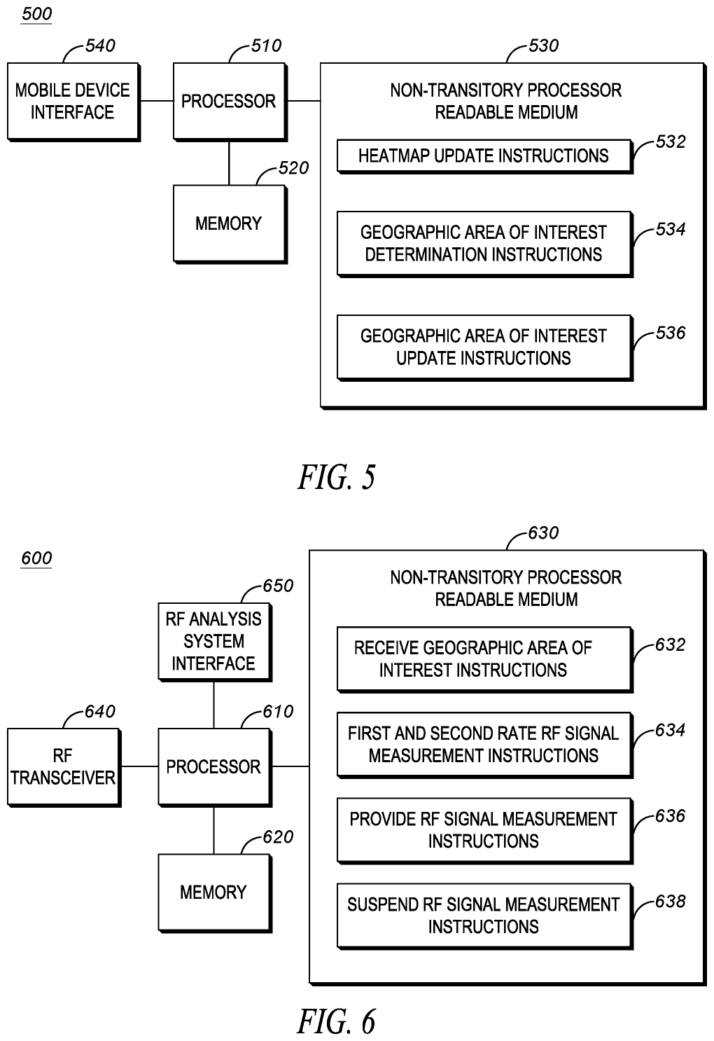

FIG. 5 is an example of an RF analysis system that may implement the RF signal metric collection techniques described herein. RF analysis system 500 may be any type of system or device that is able to create and update an RF coverage heatmap as described with respect to FIGS. 1 and 2. For example, RF analysis system 500 may be a computer, such as a server computer, equipped with software to perform the RF analysis techniques described herein. RF analysis system 500 may be a computer, such as a desktop or laptop computer. What should be understood is that the RF analysis system may be implemented on many different types of computing hardware.

RF analysis system 500 may include a processor 510. The processor may be coupled to a memory 520, a non-transitory processor readable medium 530, and a mobile device interface 540. The processor may execute instructions stored on the memory to implement the techniques described herein. For example, the processor may cause processor readable instructions from the non-transitory processor readable medium 530 to be stored in the memory and the processor may execute those instructions from the memory. In some implementations, the processor may execute the instructions directly from the non-transitory processor readable medium.

The non-transitory processor readable medium 530 may contain a set of instructions thereon. Those instructions, when executed, may cause the RF analysis system 500 to implement the RF signal metric collection techniques described herein.

The medium 530 may include heatmap update instructions 532. The heatmap update instructions 532 may cause the processor to receive RF signal measurements from mobile devices. The RF coverage heatmap may then be updated based on the real, field measurements of RF signal coverage provided by the mobile devices. The medium may also include geographic area of interest determination instructions 534. As explained above, the RF analysis system may identify certain geographic areas of interest on the RF coverage heatmap. For example, these may be areas in which RF signal measurements are greater or less than the values that are expected. Geographic area of interest determination instructions 534.

The medium may also include geographic area of interest update instructions 536. Once the RF analysis system has identified geographic areas of interest (e.g. using instructions 534), those areas of interest may be sent to mobile devices. As explained above, mobile devices may take RF signal measurements at a first rate when outside a geographic area of interest and at a second rate when inside a geographic area of interest. Geographic area of interest update instructions 536 may be executed in order to send the geographic areas of interest to the mobile device. The operation of the instructions contained on medium 530 are described in more detail with respect to FIGS. 1 and 2 and the example flow chart depicted in FIG. 3.

RF analysis system 500 may also include mobile device interface 540. As explained above, RF analysis system may interface with Mobile devices for multiple reasons. For example, mobile device interface 540 may be utilized to send updated geographic areas of interest to the mobile device. As another example, mobile device interface 540 may be utilized to receive RF signal measurements from the mobile device.

The techniques described herein are not dependent on any particular type of mobile device interface 540. For example, the mobile device interface may be an RF transceiver that allows the RF analysis system to communicate directly with the mobile device over a wireless network. The mobile device interface may be a data interface to the wireless system itself (which may then utilize an RF transceiver to communicate with the mobile device). The mobile device interface may be a short range wired or wireless (e.g. Bluetooth, Wi-Fi, etc.) connection to the mobile device. The techniques described herein are not dependent upon any certain technology. Any technology that allows RF signal measurements to be received from mobile device and allows geographic areas of interest to be sent to mobile devices is suitable for use with the techniques described herein.

FIG. 6 is an example, of a mobile device that may implement the RF signal metric collection techniques described herein. Device 600 may be any type of wireless device that is able to take RF signal measurements. For example, device 600 may be a mobile phone or an LMR two-way radio. Device 600 may be any type of device that has the ability to take RF signal measurements at a first and second rate (or to stop taking RF measurements completely) and provide those measurements to an RF analysis system. Device 600 may be any type of device that includes positioning functionality (e.g. GPS location) in order for the device to know where, within a geographic region, the device is currently located. Device 600 may be any type of device that is able to receive indications of geographic areas of interest in order to determine when it should take RF measurements at the first or second rate.

Device 600 may include a processor 610. The processor may be coupled to a memory 620, a non-transitory processor readable medium 630, and a RF transceiver 640. The processor may execute instructions stored on the memory to implement the techniques described herein. For example, the processor may cause processor readable instructions from the non-transitory processor readable medium 630 to be stored in the memory and the processor may execute those instructions from the memory. In some implementations, the processor may execute the instructions directly from the non-transitory processor readable medium.

The non-transitory processor readable medium 630 may contain a set of instructions thereon. Those instructions, when executed, may cause the device 600 to implement the RF signal metric collection techniques described herein.

The medium 630 may include receive geographic area of interest instructions 632. The receive geographic area of interest instructions may cause the device to receive geographic areas of interest from the RF analysis system described above. The medium 630 may also include first and second rate RF signal measurement instructions 634. Based on the geolocation capabilities of the device (e.g. GPS), the device may know whether it is inside or outside a geographic area of interest. Using first and second rate RF signal measurement instructions 634, the device may take RF signal measurements at a first rate when outside a geographic area of interest and may take RF signal measurements at a second rate when inside a geographic area of interest.

The medium 630 may also include provide RF signal measurement instructions 636. The provide RF signal measurement instructions 636 may cause the device to provide the RF signal measurements to an RF analysis system (which may update an RF coverage heatmap accordingly). As explained above, in some implementations, the mobile device may provide those measurements using the wireless network for which it is taking RF signal measurements. In other implementations, the device may provide RF signal measurements to the RF analysis system directly through a wired or high speed local wireless connection. The medium may also include suspend RF signal measurement instructions 638. In some circumstances (e.g. device is stationary, device is in an excluded region, etc.) it may be desired that the device suspend taking RF signal measurements. Suspend RF signal measurement instructions 638 may be used to determine when the device should suspend taking RF signal measurements. The operation of the instructions contained on medium 630 are described in more detail with respect to FIGS. 1 and 2 and the example flow chart depicted in FIG. 4.

Device 600 may also include RF transceiver 640. RF transceiver 640 may allow device 600 to take RF signal measurements of the wireless network that is covering a geographic area. RF transceiver 640 may be capable of taking any type of RF signal measurement that would be useful for an RF analysis system to create and update and RF coverage heatmap. In addition, RF transceiver 640 may be used by device 600 in order to receive geographic areas of interest from an RF analysis system.

Device 600 may also include RF Analysis System interface 650. RF analysis system interface 650 may be used to allow device 600 to communicate RF signal measurements to the RF analysis system. In some implementations, the RF analysis system interface may utilize RF transceiver 640 to send RF signal measurements to the RF analysis system. In other implementations, RF analysis system interface may be a wired or local high speed wireless (e.g. Wi-Fi, Bluetooth, etc.) connection to the RF analysis system.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
a) sending, periodically, from a radio frequency (RF) analysis system, to a mobile device, an indication of at least one geographic area of interest, wherein the at least one geographic area of interest is based on an RF coverage heatmap;
b) receiving, from the mobile device, RF signal measurements, wherein the mobile device takes RF signal measurements at a first rate when outside the at least one geographic area of interest and at a second rate when within the at least one geographic area of interest;
c) updating the RF coverage heatmap based on the received RF signal measurements; and
d) updating the at least one geographic area of interest based on the updated RF coverage heatmap.

2. The method of claim 1 further comprising:
repeating steps a-d.

3. The method of claim 1 wherein the RF coverage heatmap includes expected RF signal measurements based on RF coverage calculations.

4. The method of claim 1 further comprising:
determining RF signal measurements are lower than expected in a geographic area; and
including the geographic area in the at least one geographic area of interest.

5. The method of claim 1 further comprising:
detecting a suspected RF dead spot on the RF coverage heatmap; and
sending an alert to the mobile device indicating a location of the suspected RF dead spot, wherein the mobile device collects more detailed RF signal measurements when located within the suspected RF dead spot.

6. The method of claim 1 further comprising:
correlating environmental conditions with the received RF signal measurements.

7. The method of claim 1 further comprising:
receiving antenna orientation information from the mobile device; and
correlating the antenna orientation information with the RF signal measurements.

8. A non-transitory processor readable medium containing a set of instructions thereon that when executed by the processor cause the processor to:
a) send, periodically, from a radio frequency (RF) analysis system, to a mobile device, an indication of at least one geographic area of interest, wherein the at least one geographic area of interest is based on an RF coverage heatmap;
b) receive, from the mobile device, RF signal measurements, wherein the mobile device takes RF signal measurements at a first rate when outside the at least one geographic area of interest and at a second rate when within the at least one geographic area of interest;
c) update the RF coverage heatmap based on the received RF signal measurements; and
d) update the at least one geographic area of interest based on the updated RF coverage map.

9. The medium of claim 8 further comprising instructions to:
repeat steps a-d.

10. The medium of claim 8 wherein the RF coverage heatmap includes expected RF signal measurements based on RF coverage calculations.

11. The medium of claim 8 further comprising instructions to:
determine RF signal measurements are lower than expected in a geographic area; and
include the geographic area in the at least one geographic area of interest.

12. The medium of claim 8 further comprising instructions to:
detect a suspected RF dead spot on the RF coverage heatmap; and
send an alert to the mobile device indicating a location of the suspected RF dead spot, wherein the mobile device collects more detailed RF signal measurements when located within the suspected RF dead spot.

13. The medium of claim 8 further comprising instructions to:
correlate environmental conditions with the received RF signal measurements.

14. The medium of claim 8 further comprising instructions to:
receive antenna orientation information from the mobile device; and
correlate the antenna orientation information with the RF signal measurements.

15. A method comprising:
receiving, periodically, at a mobile device including a radio frequency (RF) transceiver, an indication of at least one geographic area of interest, the at least one geographic area of interest determined by a heatmap including RF signal measurements of a geographic area;
taking, by the mobile device, RF signal measurements at a first rate when the mobile device is outside the at least one geographic area of interest;
taking RF signal measurements at a second rate when the mobile device is inside the at least one geographic area of interest, wherein the second rate is higher than the first rate; and
providing the RF signal measurements taken at the first and second rates to an RF analysis system, wherein the RF signal measurements include geographic location information, wherein the RF analysis system updates the heatmap, periodically, by incorporating the RF signal measurements taken at the first and second rates into the heatmap and generates new geographic areas of interest based on the updated heatmap.

16. The method of claim 15 further comprising:
receiving, periodically, by the mobile device, the new geographic areas of interest.

17. The method of claim 15 further comprising:
suspending RF signal measurements when the mobile device is in an excluded geographic region.

18. The method of claim 15 further comprising:
suspending RF signal measurements when the mobile device is stationary.

19. The method of claim 15 further comprising:
storing the RF signal measurements taken at the first and second rates locally on the mobile device; and
providing the RF signal measurements to the RF analysis system when connected to the RF analysis system over a local connection.

20. The method of claim 15 further comprising:
taking RF signal measurements at the second rate when the mobile device is outside the at least one geographic area of interest and the RF signal measurements have fallen below a threshold.
